(19) United States
(12) Patent Application Publication
(10) Pub. No.: US 2007/0132354 A1
(43) Pub. Date: Jun. 14, 2007

(54) Spark plugs and methods of making the same

(76) Inventors: Barry L. Scott, Davison, MI (US); Daryl W. Spaulding, Grand Blanc, MI (US); Jerry J. Okenka, Swartz Creek, MI (US); David J. Draeger, Bryon Center, MI (US)

Correspondence Address: Paul L. Marshall;Delphi Technologies, Inc., M/C 480-410-202, P.O. Box 5052, Troy, MI, 48007, US

(21) Appl. No.: 11/301,089

(22) Filed: Dec. 12, 2005

(51) Int. Cl. H01T 13/20

(52) U.S. Cl. 313/141

(57) ABSTRACT

In one embodiment, a spark plug comprises: an electrically nonconductive body disposed in an electrically conductive shell; a side electrode extending from said shell; a sheath disposed within and protruding from a body first end of the electrically nonconductive body; a core disposed in the cavity; and a center electrode tip extending from the cavity through the opening. The sheath comprises a cavity extending from a sheath second end toward a sheath first end. The cavity connects to an opening disposed through the first end. The core is in electrical communication with the center electrode tip. The center electrode tip is in alignment with the side electrode.

### BACKGROUND

Spark ignition of an internal combustion engine generally involves igniting an air/fuel mixture with an electric spark generated between a center electrode and a ground electrode of a spark plug. The facing surfaces of the center and ground electrodes are typically flat, and serve as arcing or firing surfaces between which the electric spark is generated. Typically, the electrodes are formed from a nickel-base alloy which is resistant to the harsh electrical, thermal, chemical and mechanical environment of an engine's combustion chamber. The nickel-base alloy is often applied over a copper core which improves the thermal conductivity of the electrodes.

Precious metal can be substituted for the nickel alloys for the purpose of extending the life of the electrode. The use of a precious metal electrode is particularly advantageous when attempting to minimize the size of the electrode, which serves to lower the demand voltage of a spark plug. To minimize the amount of precious metal required, a precious metal firing tip, such as a thin platinum alloy disk, may be attached to the firing surface of an otherwise nickel alloy electrode for the purpose of minimizing the amount of precious metal required. Firing tips having minimal mass are welded to and project from the spark plug's ground and center electrodes. As a result, the firing tips are specifically configured to benefit from the advantages noted above with smaller electrodes.

Currently, laser or resistance welding methods are used to attach the center electrode tip to a center electrode casing. However, the precious metal tips have high melting points making welding processes inefficient. Therefore, a continuing need exists to simplify spark plug production and to reduce costs.

### SUMMARY

Disclosed herein are spark plugs and method for making the same. In one embodiment, a spark plug comprises: an electrically nonconductive body disposed in an electrically conductive shell; a side electrode extending from said shell; a sheath disposed within and protruding from a body first end of the electrically nonconductive body; a core disposed in the cavity; and a center electrode tip extending from the cavity through the opening. The sheath comprises a cavity extending from a sheath second end toward a sheath first end. The cavity connects to an opening disposed through the first end. The core is in electrical communication with the center electrode tip. The center electrode tip is in alignment with the side electrode.

In one embodiment, a method of making a spark plug comprises: forming a sheath comprising a cavity extending from a sheath second end toward a sheath first end; disposing a center electrode tip in the cavity such that the center electrode tip extends from the cavity through the opening; disposing a core in the cavity to form an assembly; disposing the sheath in electrically nonconductive body such that the sheath protrudes from a body first end; and disposing the electrically nonconductive body in an electrically conductive shell comprising a side electrode extending from the shell. The cavity connects to an opening disposed through the first end. The core is in electrical communication with the center electrode tip. The center electrode tip is in alignment with the side electrode such that a spark can be formed in a gap between the center electrode tip and the side electrode.

The above described and other features are exemplified by the following figures and detailed description.

### BRIEF DESCRIPTION OF THE DRAWINGS

Refer now to the figures, which are exemplary embodiments, and wherein like elements are numbered alike.

FIG. 1 illustrates a cross-sectional view of an embodiment of a spark plug.

FIG. 2 illustrates a cross-sectional view of an embodiment of a spark plug center electrode.

### DETAILED DESCRIPTION

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Ranges disclosed herein are inclusive and independently combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.).

A spark plug generally includes center and ground electrodes which define a spark gap across which an electric spark can be generated for igniting a fuel mixture within the combustion chamber of an internal combustion engine. Integrated into the electrode(s) is a firing tip, such that the firing tips are aligned to be approximately coaxial. The firing tips can comprise precious metal(s) (e.g., a precious metal alloy) to enhance erosion protection during operation.

The spark plug includes an electrically conductive shell which defines the longitudinal axis of the plug, and an electrically nonconductive body, or insulator body, disposed along the longitudinal axis. The center electrode typically projects from the nonconductive body substantially along the longitudinal axis, while the ground electrode projects from the shell, terminating at a distal end. A firing tip is integrated into the center electrode so as to be axially spaced from the insulator body, such that the firing tip provides a firing location axially spaced from the insulator body.

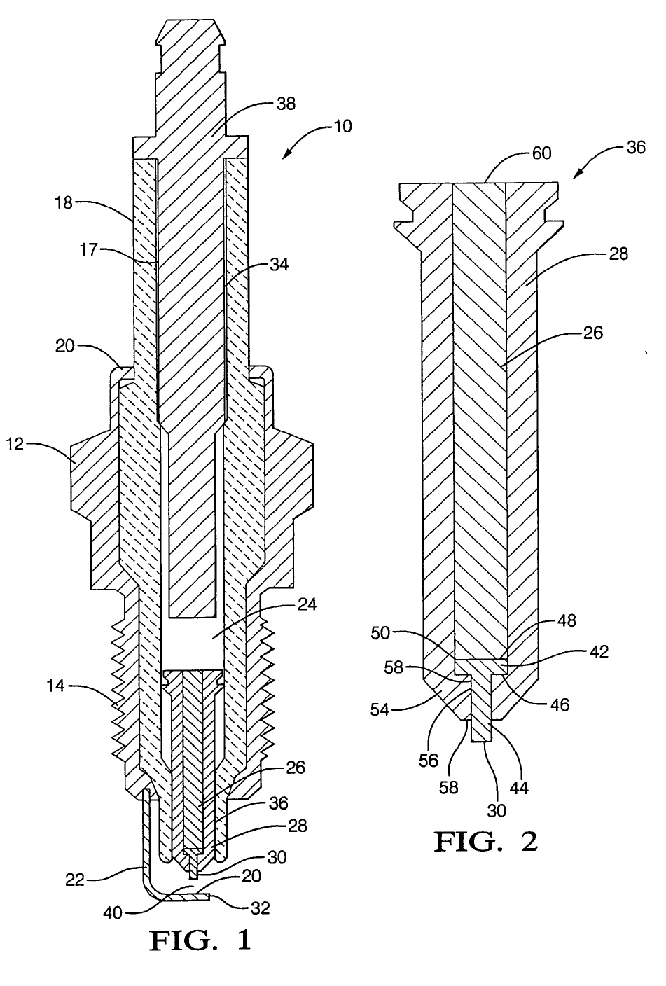

Although described in relation to FIGS. 1 and 2, the spark plug can comprise various designs, such at the electrode arrangement set forth in European Patent No. 0701331 A1. As illustrated in FIG. 1, the spark plug 10 can include an electrically conductive shell 12, e.g., comprising steel. External threads 14 are formed at one end of the shell 12 for installing the spark plug 10, e.g., into a threaded hole in a wall of a combustion chamber within an internal combustion engine (not shown). An insulator body 18, generally formed from a ceramic material such as alumina (Al₂O₃), is secured within the shell 12 in any suitable manner, such as by crimping. A gasket of a suitable temperature resistant material, such as copper, steel, and so forth, can be provided between the shell 12 and the insulator body 18 to help create a gas tight seal therebetween. The insulator body 18 projects through the end of the shell 12 opposite the threads 14. The portion of the insulator body 18 which projects from the shell 12 has a passage 17 which receives a terminal post 34, by which an electric current can be supplied to the spark plug 10. Located at the end of the spark plug 10 opposite the terminal post 34 is a side electrode 22. The side electrode 22 can be an L-shaped metal member welded to the shell 12, e.g., allowing the shell 12 to conduct electric current and heat to the engine block (not shown).

The side electrode 22 extends from a second end of the electrically conductive shell 12 to be in alignment with the center electrode tip 30 such that a spark can be formed in the gap 40 therebetween. The side electrode 22 can comprise an electrically and thermally conductive material such as copper (Cu), niobium (Nb), silver (Ag), and so forth, as well as alloys comprising at least one of the foregoing materials, and combinations comprising at least one of the foregoing; such as zirconium (Zr), chromium (Cr), nickel (Ni), titanium (Ti), silicon (Si), manganese (Mn), iron (Fe), and/or carbon (C), and so forth. Optionally, the side electrode can comprise a side electrode tip 20. The side electrode tip, which is attached to the side electrode 22 in alignment with the center electrode tip 30, can comprise precious metal(s) such as platinum, palladium, ruthenium, iridium, and so forth, as well as alloys comprising at least one of the foregoing, and combinations comprising at least one of the foregoing; e.g., platinum-nickel alloy, palladium-ruthenium alloy, platinum-iridium alloy, and so forth.

Disposed within the shell 12 is the electrically nonconductive body 18 that insulates the center electrode 30 from the shell 12 and provides structural stability to the spark plug 10 under operating conditions. The insulator body 18 can comprise, for example, ceramic components such as alumina (e.g., aluminum oxide, Al₂O₃), or other electrically insulating material that can withstand temperatures typically found in internal combustion engines and temperature cycling.

The insulator body 18 surrounds the terminal post 34. The terminal post 34 comprises an upper portion 38 which serves as the electrical and mechanical interface with the high voltage electrical energy source, and a resistor section 24 (e.g., comprising a glass seal, or the like). The center electrode 36 (comprising the core 26, sheath 28 and tip 30). The side electrode 22 includes an outermost end 32 that is positioned in cooperative relation (or coaxially aligned) to the tip 30 of the center electrode 36.

The center electrode 36 includes a tip 30, a core 26, and a sheath 28. (see also FIG. 2) The sheath comprises a converging end 54 comprising an opening 56 extending from the sheath cavity 60 (comprising the core 26) to the sheath end 58. The opening 56, which can be aligned with the side electrode tip, can have a size and geometry for receiving the center electrode tip 30.

The center electrode tip 30 can comprise a head portion 42 and a body portion 44. The body portion extends through the opening 56, and has a length that is greater than the opening length. The head portion 42 has a size and geometry to inhibit the head portion 42 from passing through the opening 56. This head portion 42 can have a width (e.g., diameter) that is less than or equal to the diameter of the sheath cavity 60 comprising the core 26 and greater than the width (e.g., diameter) of the opening 56 (or that at least prevents the tip 30 from passing out of the opening 56 (e.g., a triangular shape that engages the surface of the sheath cavity 60 adjacent the opening 56 (e.g., engages a shelf formed at the bottom of the cavity at the mouth of the opening)). Alternatively, the head portion 42 can have a bar shape (e.g., such that the tip 30 has T-like or similar shape) such that the head portion 42 engages the surface of the cavity 60 adjacent the opening 56 at two points.

The center electrode tip 30 comprises material capable of conducting a spark across the spark gap 40 and capable of withstanding the harsh environment of the combustion chamber. Material for the center electrode tip 30 includes precious metal(s) such as platinum, palladium, ruthenium, iridium, and so forth, as well as alloys comprising at least one of the foregoing, and combinations comprising at least one of the foregoing; e.g., platinum-nickel alloy, palladium-ruthenium alloy, platinum-iridium alloy, and so forth.

The head portion 42 is in electrical communication, and optionally physical contact, with the core 26. The core 26 can comprise an electrically and thermally conductive material capable of withstanding the combustion conditions, such as copper, niobium, silver, and so forth, as well as alloys comprising at least one of the foregoing materials, and combinations comprising at least one of the foregoing; such as zirconium, chromium, nickel, titanium, silicon, manganese, iron, and/or carbon, and so forth. Exemplary spark plug core materials are disclosed in U.S. Pat. No. 6,677,698 to LaBarge et al., and U.S. Pat. No. 5,530,313 to Chiu, which are incorporated herein.

The core 26 is disposed through the sheath 28. In order to enhance the life of the spark plug, the core 26 can be annealed to the sheath 28. The sheath 28 can comprise material capable of withstanding the harsh environment of an engine, and of providing structural integrity to the core 26 and tip 30. The sheath 28 can comprise an oxidation-resistant material such as nickel (Ni), chromium (Cr), and so forth, as well as alloys comprising at least one of the foregoing, and combinations comprising at least one of the foregoing. For example, the sheath 28 can comprise Inconel® 600 (containing 76 wt % Ni, 15.5 wt % Cr, 8 wt % iron (Fe)), Inconel® 601 (containing 60.5 wt % Ni, 23 wt % Cr, 14 wt % Fe), both commercially available from Inco Alloys International, Inc., Huntington, W.V.).

The spark plug can be formed by various methods. The sheath 28 can be formed using various metal forming processes such as casting, molding, cold forming, and the like. The center electrode tip 30 can then be disposed into the cavity 60 such that the body portion 44 extends through the opening 56 into the spark gap 40. The core 26 can then be disposed (e.g., injected, extruded, pressed (e.g., cold forming), or the like) in the cavity 60 to conform to the cavity 60 as well as the head portion 42, forming an intimate contact therewith.

This proposed design of the spark plug, e.g., with a precious metal tip that extends through the sheath, eliminates the requirement to weld (e.g., resistance weld) the tip to the core. This simplifies the spark plug and makes it more reliable.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A spark plug, comprising:
an electrically nonconductive body disposed in an electrically conductive shell;
a side electrode extending from said shell;
a sheath disposed within and protruding from a body first end of the electrically nonconductive body, wherein the sheath comprises a cavity extending from a sheath second end toward a sheath first end, wherein the cavity connects to an opening disposed through the first end;
a core disposed in the cavity; and
a center electrode tip extending from the cavity through the opening,
wherein the core is in electrical communication with the center electrode tip, and
wherein the center electrode tip is in alignment with the side electrode.

2. The spark plug of claim 1, wherein the side electrode further comprises a side electrode tip in alignment with the center electrode tip, and wherein the side electrode tip and the center electrode tip comprise a precious metal selected from the group consisting of platinum, palladium, ruthenium, iridium, alloys comprising at least one of the foregoing, and combinations comprising at least one of the foregoing.

3. The spark plug of claim 1, wherein the center electrode tip comprises an electrode width that is greater than a width of the opening.

4. The spark plug of claim 3, wherein the center electrode tip comprises a head portion has a geometry designed to retain the tip in the center electrode.

5. The spark plug of claim 4, wherein the head portion that engages a surface of the cavity at the opening.

6. The spark plug of claim 1, wherein the center electrode tip is not welded to the core and/or sheath.

7. The spark plug of claim 1, wherein the center electrode tip protrudes from the opening.

8. A method of making a spark plug, comprising:
forming a sheath comprising a cavity extending from a sheath second end toward a sheath first end, wherein the cavity connects to an opening disposed through the first end;
disposing a center electrode tip in the cavity such that the center electrode tip extends from the cavity through the opening;
disposing a core in the cavity to form an assembly, wherein the core is in electrical communication with the center electrode tip;
disposing the sheath in electrically nonconductive body such that the sheath protrudes from a body first end; and
disposing the electrically nonconductive body in an electrically conductive shell comprising a side electrode extending from the shell, wherein the center electrode tip is in alignment with the side electrode such that a spark can be formed in a gap between the center electrode tip and the side electrode.

9. The method of claim 8, further comprising conforming the core to the shape of the cavity.

10. The method of claim 8, wherein the center electrode tip comprises an electrode width that is greater than a width of the opening.

11. The method of claim 8, wherein the center electrode tip comprises a head portion that has a geometry designed to retain the tip in the center electrode.

12. The method of claim 11, wherein the head portion that engages a surface of the cavity at the opening.

13. The method of claim 8, wherein the center electrode tip is not welded to the core and/or sheath.

14. The method of claim 8, wherein the center electrode tip protrudes from the opening.
